(19) United States
(12) Patent Application Publication
(10) Pub. No.: US 2006/0176801 A1
(43) Pub. Date: Aug. 10, 2006

(54) Method of manufacturing reverse disk

(75) Inventors: Nobuhiko Fujiwara, Odawara-shi (JP); Mikio Tomaru, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/325,473

(22) Filed: Jan. 5, 2006

(30) Foreign Application Priority Data
Feb. 4, 2005 (JP) 2005-029571

(51) Int. Cl. G11B 7/24; G11B 7/26

(52) U.S. Cl. 369/275.1; 369/283; 369/272.1

(57) ABSTRACT

The present invention provides a method of manufacturing a reverse disk, comprising the steps of: forming a conductive layer on a surface of an original disk where concavo-convex patterns are formed; forming a reverse disk made of a metal plate having a prescribed thickness by immersing the original disk in an electrolyte and electrodepositing a metal on a surface of the conductive layer; and exfoliating the reverse disk from the original disk after the formation of the reverse disk, wherein an ambient temperature around the original disk and/or a temperature of the original disk in the step of forming the conductive layer and/or before the step of forming the conductive layer are controlled within±10° C. of a liquid temperature of the electrolyte.

### BACKGROUND OF THE INVENTION

1. Field of the Invention

The present invention relates to a method of manufacturing a reverse disk and, more particularly, to a method of manufacturing a reverse disk which is suitable for the manufacture of master disks on which concavo-convex patterns corresponding to information are formed, such as a master disk for magnetic transfer used in magnetic transfer and a master disk for optical disk used in the formation of an optical disk, and also suitable for the manufacture of optical elements on which concavo-convex patterns are formed, such as an antireflection film, an antidazzling film and a diffraction grating.

2. Description of the Related Art

In a magnetic disk (a hard disk) which is used in a hard disk drive which has rapidly come into wide use in recent years, it is general practice that format information and address information are written before the magnetic disk (the hard disk) is incorporated into the drive after delivery from a magnetic disk maker to a drive maker. Although this writing can also be performed by use of a magnetic head, it is efficient and desirable to perform collective transfer from a master disk in which these format information and address information are written.

In such magnetic transfer, a master disk on which transfer patters of servo signal etc. are formed in concavo-convex shape (a patterned master disk) and a disk targeted for transfer which has magnetic recording sections, such as a hard disk and a flexible disk(a slave disk), are brought into close contact with each other, and in this condition, magnetic fields for transfer are applied to these objects in close contact, whereby magnetization patterns corresponding to the information which is carried by the master disk are transferred to the slave disk and recorded therein.

As a master disk used in the above-described magnetic transfer, in the Japanese Patent Application Laid-Open No. 2001-256644, for example, there has been proposed a master disk in which concavo-convex patterns corresponding to information signals are formed on the surface of a substrate and a thin-film magnetic layer is formed by coating on the surface of the concavo-convex patterns.

This master disk is manufactured by the following process, for example. First, an electron ray resist or a photoresist is applied to a Si substrate having a smooth surface, transfer patters are drawn and exposed by electron beams or light etc. and developed, whereby an original disk having concavo-convex patterns formed by the resist is obtained.

Next, a conductive layer is provided on the concavo-convex patterns of this original disk, for example, by sputtering, the original disk provided with this conductive layer is immersed in an electrolyte, and Ni is electrodeposited on the conductive layer, whereby a metal plate (a reverse disk) having a prescribed thickness is obtained. And the metal plate is exfoliated from the original disk, a master disk is fabricated by punching the exfoliated metal plate with a prescribed size, and a magnetic layer is formed on the surface of the concavo-convex patterns of the master substrate. As a result of this, a master disk for magnetic transfer is manufactured.

Such a technology for the formation of a reverse disk as described above is used not only in the manufacture of a master disk for magnetic transfer, but also in other fields, for example, in the manufacture of a stamper for the manufacture of an optical disk, an optical card and other light-applied plastic products as described in the Japanese Patent Application Laid-Open No. 2-8392.

### SUMMARY OF THE INVENTION

However, when a master disk is manufactured by a manufacturing method as described above, the lamination of a metal plate on an original disk is performed in an electrolyte during heating. Therefore, for example, if after the lamination of the metal plate, the original disk on which the metal plate has been laminated is taken out into the air and the metal plate is exfoliated from the original disk when the temperature has dropped to a certain extent, because of a difference in the coefficient of thermal expansion between Si, which is the material for the original disk, and Ni, which is the material of the metal plate, Si and Ni have different degrees of contraction during cooling. Therefore, it is impossible to accurately form concavo-convex patterns, which correspond to the concavo-convex patterns formed in the original disk, in the metal plate and partially broken and lost portions occur in the concavo-convex patterns of the metal plate.

In contrast to this, in the Japanese Patent Application Laid-Open No. 2-8392, there is proposed a method which involves laminating a metal plate on an original disk in an electrolyte, then transferring the original disk on which the metal plate has been laminated into cleaning water at the same temperature as the electrolyte, performing cooling by gradually lowering the temperature of the cooling water to room temperature, and exfoliating thereafter the metal plate from the original disk. However, also in this method, it has been experimentally ascertained that problems as described above arise.

The present invention has been made in view of such circumstances and has as its object the provision of a method of manufacturing a reverse disk which can more accurately form concavo-convex patterns corresponding to concavo-convex patterns formed on an original disk in the formation of a reverse disk for the manufacture of a master disk as described above.

To achieve the above-described object, the present invention provides a method of manufacturing a reverse disk which comprises the steps of: forming a conductive layer on a surface of an original disk where concavo-convex patterns are formed; forming a reverse disk made of a metal plate having a prescribed thickness by immersing the original disk in an electrolyte and electrodepositing a metal on the surface of the conductive layer; and exfoliating the reverse disk from the original disk after the formation of the reverse disk. In this method, the ambient temperature around the original disk and/or the temperature of the original disk in the step of forming the conductive layer and/or before the step of forming the conductive layer are controlled within±10° C. of the liquid temperature of the electrolyte.

According to the present invention, the ambient temperature around the original disk and/or the temperature of the original disk in the step of forming the conductive layer and/or before the step of forming the conductive layer are controlled within±10° C. of the liquid temperature of the electrolyte. Therefore, in the formation of a conductive layer, it is possible to form a denser conductive layer than at room temperature. As a result of this, the effect that defects are less apt to occur on the surface of an electroformed reverse disk is obtained.

From the above-described viewpoint, the ambient temperature around the original disk and/or the temperature of the original disk in the step of forming the conductive layer and/or before the step of forming the conductive layer are controlled more preferably within±5° C. of the liquid temperature of the electrolyte and most preferably within±1° C. thereof.

The present invention also provides a method of manufacturing a reverse disk which comprises the steps of: forming a conductive layer on a surface of an original disk where concavo-convex patterns are formed; forming a reverse disk made of a metal plate having a prescribed thickness by immersing the original disk in an electrolyte and electrodepositing a metal on the surface of the conductive layer; and exfoliating the reverse disk from the original disk after the formation of the reverse disk. In this method, the ambient temperature around the reverse disk and/or the temperature of the reverse disk in the step of exfoliating and/or before the step of exfoliating are controlled within±10° C. of the liquid temperature of the electrolyte.

According to the present invention, the ambient temperature around the original disk and/or the temperature of the original disk in the step of exfoliating and/or before the step of exfoliating are controlled within±10° C. of the liquid temperature of the electrolyte. Therefore, the effect of the coefficient of thermal expansion can be reduced and concavo-convex patterns corresponding to concavo-convex patterns formed on an original disk can be more accurately formed on the reverse disk (the metal plate).

From the above-described viewpoint, the ambient temperature around the reverse disk and/or the temperature of the reverse disk in the step of exfoliating and/or before the step of exfoliating are controlled more preferably within±5° C. of the liquid temperature of the electrolyte and most preferably within±1° C. thereof.

The present invention also provides a method of manufacturing a reverse disk which comprises the steps of: forming a conductive layer on a surface of an original disk where concavo-convex patterns are formed; forming a reverse disk made of a metal plate having a prescribed thickness by immersing the original disk in an electrolyte and electrodepositing a metal on the surface of the conductive layer; and exfoliating the reverse disk from the original disk after the formation of the reverse disk. In this method, the ambient temperature around the original disk and/or the temperature of the original disk in the step of forming the conductive layer and/or before the step of forming the conductive layer and the ambient temperature around the reverse disk and/or the temperature of the reverse disk in the step of exfoliating and/or before the step of exfoliating are controlled within±10° C. of the liquid temperature of the electrolyte.

According to the present invention, the ambient temperature around the original disk and/or the temperature of the original disk in the step of forming the conductive layer and/or before the step of forming the conductive layer are controlled within±10° C. of the liquid temperature of the electrolyte. Therefore, in the formation of a conductive layer, it is possible to form a denser conductive layer than at room temperature. As a result of this, the advantage that defects are less apt to occur on the surface of an electroformed reverse disk is obtained. Also, the ambient temperature around the reverse disk and/or the temperature of the reverse disk in the step of exfoliating and/or before the step of exfoliating are controlled within±10° C. of the liquid temperature of the electrolyte. Therefore, the effect of the coefficient of thermal expansion can be reduced and concavo-convex patterns corresponding to concavo-convex patterns formed on an original disk can be more accurately formed on the reverse disk (the metal plate).

From the above-described viewpoint, the ambient temperature around the original disk and/or the temperature of the original disk in the step of forming the conductive layer and/or before the step of forming the conductive layer and the ambient temperature around the reverse disk and/or the temperature of the reverse disk in the step of exfoliating and/or before the step of exfoliating are controlled more preferably within±5° C. of the liquid temperature of the electrolyte and most preferably within±1° C. thereof.

In the present invention, it is preferred that the temperature control of the original disk in the step of forming the conductive layer be performed within a conductive layer forming device. If the temperature control of the original disk in the step of forming the conductive layer is performed within a conductive layer forming device (for example, within a chamber of a sputtering device) like this, then the temperature control is easy.

Also, in the present invention, it is preferred that the temperature control of the original disk and/or the reverse disk in the step of exfoliating and/or before the step of exfoliating be performed within a constant-temperature device. If the temperature control of the original disk and/or the reverse disk in the step of exfoliating and/or before the step of exfoliating is performed within a constant-temperature device (for example, within a constant temperature bath or within a constant temperature oven), then the temperature control is easy.

As described above, according to the present invention, in the formation of a conductive layer, it is possible to form a denser conductive layer than at room temperature. As a result of this, the advantage that defects are less apt to occur on the surface of an electroformed reverse disk is obtained.

Also, according to the present invention, the effect of the coefficient of thermal expansion can be reduced and concavo-convex patterns corresponding to concavo-convex patterns formed on an original disk can be more accurately formed on the reverse disk (the metal plate).

### BRIEF DESCRIPTION OF THE DRAWINGS

FIG. 1 is a partially enlarged perspective view of a master disk for magnetic transfer manufactured by a method of manufacturing a reverse disk related to the present invention;

FIG. 2 is a plan view of a master disk for magnetic transfer;

FIGS. 3A to 3G are sectional views which show steps in order in the manufacture of a master disk for magnetic transfer by a method of manufacturing a reverse disk related to the present invention;

FIG. 4 is a sectional view of an electroforming device and an exfoliation bath; and

FIGS. 5A to 5D are sectional views which show another example of manufacture of a master disk for magnetic transfer by a method of manufacturing a reverse disk related to the present invention in order of steps.

### DETAILED DESCRIPTION OF THE PREFERRED EMBODIMENTS

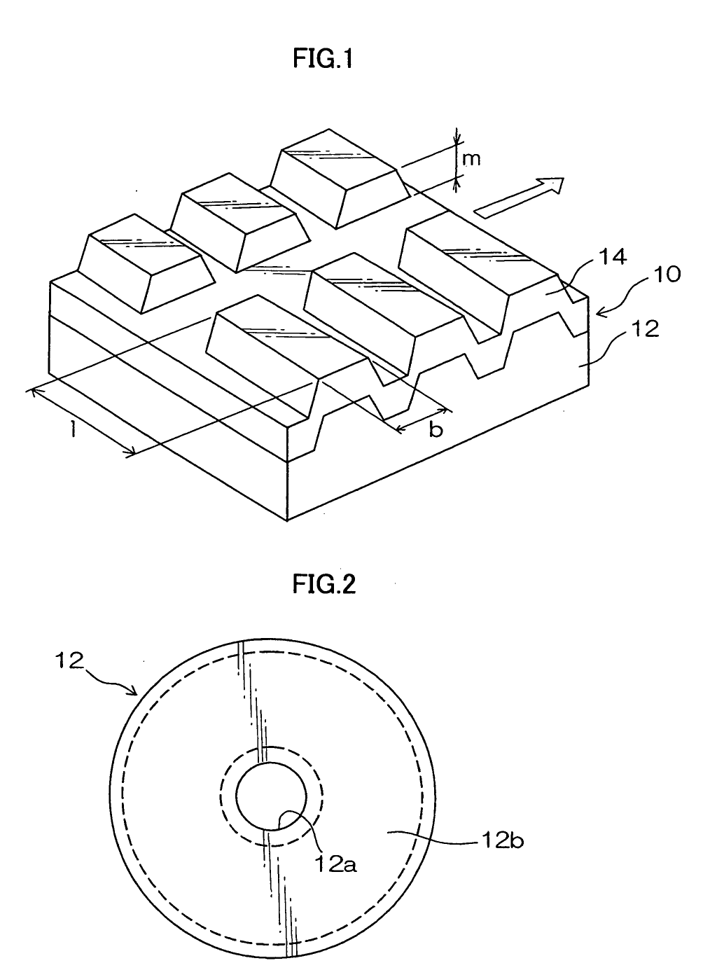

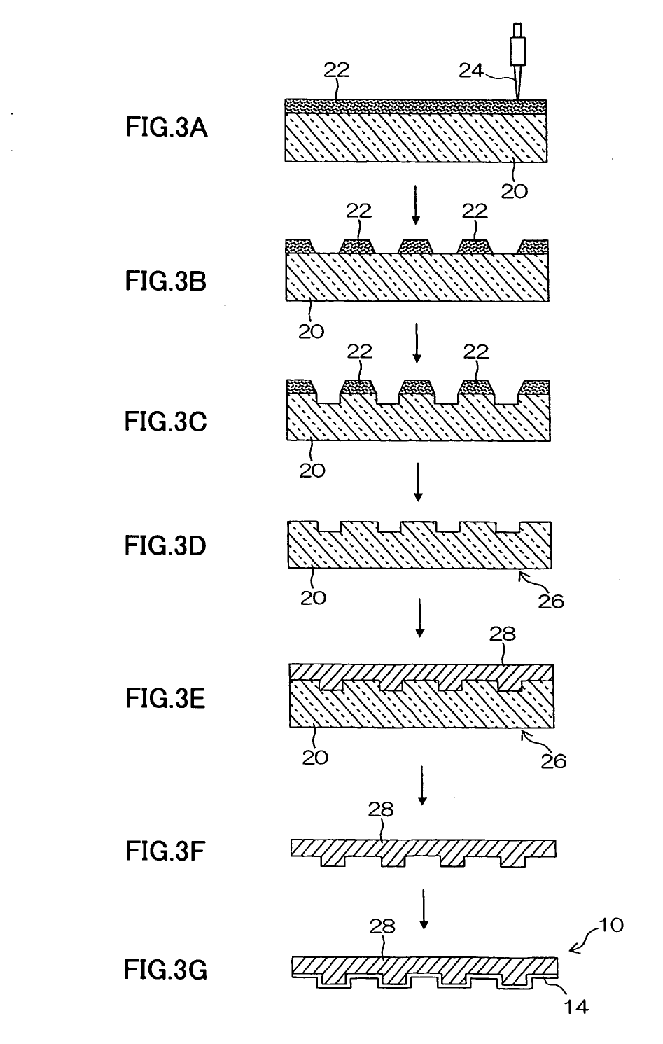

Hereinafter, a preferred embodiment of a method of manufacturing a reverse disk related to the present invention will be described in detail with reference to the attached drawings. FIG. 1 is a partially enlarged perspective view of a master disk for magnetic transfer manufactured by a method of manufacturing a reverse disk related to the present invention. FIG. 2 is a plan view of a master disk for magnetic transfer. FIGS. 3A to 3G are sectional views which show steps in order in the manufacture of a master disk for magnetic transfer by a method of manufacturing a reverse disk related to the present invention. Incidentally, each of the views is a schematic one, which is indicated at a ratio different from an actual size.

First, a master disk for magnetic transfer manufactured by a method of manufacturing a reverse disk related to the present invention will be described. As shown in FIG. 1, a master disk for magnetic transfer 10 is constituted by a master substrate 12 made of metal and a magnetic layer 14. The master substrate 12 has, on the surface thereof, fine concavo-convex patterns corresponding to transfer information and the surface is coated with the magnetic layer 14.

In FIG. 1, a transfer information carrying surface, on which fine protruding patterns by the magnetic layer 14 are formed, is formed on one surface of the master a substrate 12, and the opposite surface of the master substrate 12 is held by a close contacting device which is not shown. The formation of the fine protruding patterns is performed by a photofabrication process, which will be described later, and the like. One surface (the transfer information carrying surface) of the master disk 10 is a surface which is brought into close contact with a slave disk.

The fine protruding patterns are rectangular as plan viewed and, with the magnetic layer 14 having a thickness m formed, each protrusion is composed of a length b in the direction of tracks (the direction of the thick arrow in the figure) and a radial length 1. Although optimum values of the length b and the length 1 differ depending on recording density, the waveform of a recording signal, etc., it is possible to set the length b at 80 nm and the length 1 at 200 nm, for example.

This fine protruding pattern is formed to be radially elongated in the case of a servo signal. In this case, for example, it is preferred that the radial length 1 be 0.05 to 20 μm and that the length in the direction of tracks (the circumferential length) be 0.05 to 5 μm. It is preferred that a pattern which is radially long in these ranges be selected as a pattern which carries the information of a servo signal.

The depth of the fine protruding patters (the height of the protrusions) on the surface of the master substrate 12 is preferably in the range of 20 to 800 nm, and more preferably in the range of 30 to 600 nm.

In the master disk 10, magnetic transfer is possible with this master substrate 12 alone when the master substrate 12 is formed from a ferromagnetic material mainly composed of Ni etc., and hence the magnetic layer 14 does not always require to be applied. However, better magnetic transfer can be performed by providing a magnetic layer 14 having good transfer characteristics. When the master substrate 12 is formed from a nonmagnetic material, it is necessary to provide the magnetic layer 14. It is preferred that the magnetic layer 14 of the master disk 10 be a soft magnetic layer having a coercive force Hc of not more than 48 kA/m (≈600 Oe).

When the master substrate 12 is formed from a ferromagnetic material mainly composed of Ni etc., the master substrate 12 can be fabricated by electroforming. In this case, as shown in FIG. 2, the master disk 12 can be formed in the shape of a disk having a center hole 12a and concavo-convex patterns can be formed in an annular region 12b excepting an inner circumferential part and a peripheral part on one surface.

This master substrate 12 is fabricated, as will be described later, by laminating a metal plate of a specified thickness by electrodepositing Ni etc. on an original disk on which concavo-convex patterns corresponding to information are formed, exfoliating this metal plate from the original disk, and punching a peripheral part and the part of the center hole 12a with desired sizes.

Next, a manufacturing method of the master substrate 12 will be described on the basis of FIGS. 3A to 3G. First, as shown in FIG. 3A, an original plate 20 which is a silicon wafer (a glass plate and a quartz glass plate may also be used) having a smooth surface is subjected to base material treatment, such as adhesive layer formation. Subsequently, a resist layer 22 is formed by applying an electron-beam resist liquid by the spin coat process etc., and baking treatment (prebake) is performed.

Then, the original plate 20 is set on a stage of an electron-beam exposure device (not shown) which is provided with a high-accuracy rotary stage or X-Y stage, the original plate 20 is irradiated with electron beams 24 which have been modulated in response to servo signals while the original plate 20 is being rotated, and on substantially the whole surface of the photoresist layer 22, a prescribed pattern, for example, a pattern corresponding to a servo signal which extend linearly in the radial direction in each track from the center of rotation is drawn and exposed in portions corresponding to each frame on the circumference.

Subsequently, as shown in FIG. 3B, the resist layer 22 is subjected to development treatment, whereby exposed portions are removed and a coating layer of a desired thickness by the remaining resist layer 22 is formed. This coating layer becomes a mask in the next step (the etching step). After the development treatment, baking treatment (postbake) is performed in order to increase the adhesion between the resist layer 22 and the original plate 20.

Subsequently, as shown in FIG. 3C, the original plate 20 is removed (etched) from the opening of the resist layer 22 by a specified depth from the surface. In this etching, in order to minimize the undercut (side etching), it is desirable to perform anisotropic etching. RIE (reactive ion etching) can be preferably adopted as such anisotropic etching.

Subsequently, as shown in FIG. 3D, the resist layer 22 is removed. In removing the resist layer 22, ashing can be adopted as a dry method and a removal method by a remover liquid can be adopted as a wet method. As a result of the above-described ashing step, an original disk 26 on which a reverse form of desired concavo-convex patterns are formed is fabricated.

Subsequently, a conductive layer is formed in a uniform thickness on the surface of an original disk 26 shown in FIG. 3D. Various metal film forming processes including PVD (physical vapor deposition), CVD (chemical vapor deposition), sputtering and ionplating can be applied as methods of forming a conductive film. If a conductive layer is formed like this, it is possible to obtain also the advantage that the electrodeposition of a metal can be uniformly performed.

It is preferred that the conductive film be a film which contains Ni as a main component. Such a film which contains Ni as a main component is easy to form and is suitable as a conductive film. Although there is no limitation to the film thickness of this conductive film, tens of nanometers can be generally adopted. Because the film thickness of the conductive film is very small like this, the illustration of the conductive film is omitted.

It is required that the ambient temperature around the original disk 26 and/or the temperature of the original disk 26 in the step of forming the conductive layer and/or before the step of forming the conductive layer be controlled within±10° C. of the liquid temperature t of the electrolyte. By performing control in this manner, it is possible to form a denser conductive layer than when the ambient temperature and the temperature of the original disk are left as they are at room temperature without control, and the advantage that defects are less apt to occur on the surface of an electroformed reverse disk is obtained.

From the above-described viewpoint, the ambient temperature around the original disk 26 and/or the temperature of the original disk 26 in the step of forming the conductive layer and/or before the step of forming the conductive layer are controlled more preferably within±5° C. of the liquid temperature t of the electrolyte and most preferably within±1° C. thereof.

Incidentally, it is preferred that that the temperature control of the original disk 26 in the step of forming the conductive layer be performed within a conductive layer forming device. If the temperature control of the original disk 26 in the step of forming the conductive layer is performed within a conductive layer forming device (for example, within a chamber of a sputtering device) like this, then the temperature control is easy.

Subsequently, as shown in FIG. 3E, a metal plate 28 of a desired thickness, which is formed from a Ni metal, is laminated on the surface of the original disk 26 by performing electrodeposition (electroforming) by use of an electroforming device 30(the step of forming the reverse plate).

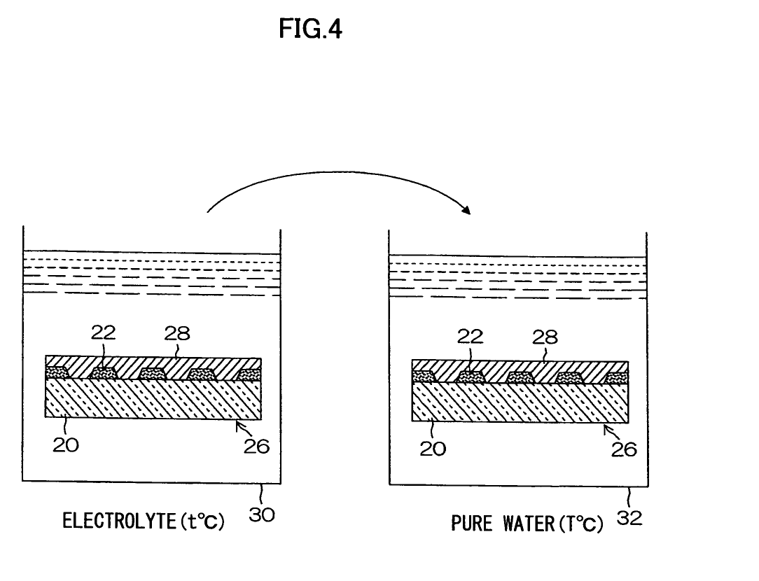

As shown in FIG. 4, this electrodeposition is performed by immersing the original disk 26 in an electrolyte at a temperature t in the electroforming device 30 and applying current to a cathode, with the original disk 26 serving as an anode. It is required that the concentration of the electrolyte, pH, how to apply current, etc. during the electrodeposition be under optimum conditions which ensure that the laminated metal plate 28 (i.e., the master substrate 12) is free from strain. Also, it is preferred that the temperature t of the electrolyte during electrodeposition be 40° C. to 70° C.

Incidentally, in the electroforming device 30 of FIG. 4, components other than the liquid tank (cathode, power source, wiring, etc.) are omitted.

And after the electrodeposition is completed as described above, the original disk 26 which is laminated with the metal plate 28 is taken out of the electrolyte in the electroforming device 30 and immersed immediately thereafter in the pure water at a temperature T within the exfoliation bath 32 as shown in FIG. 4.

In the step of exfoliating, it is required that the temperature T of the pure water when the original disk 26 on which the metal plate 28 is laminated is immersed in the pure water be controlled within±10° C. of the liquid temperature t of the electrolyte. By performing control in this manner, the effect of the coefficient of thermal expansion can be reduced more than when control is not performed and concavo-convex patterns corresponding to concavo-convex patterns formed on an original disk 26 can be more accurately formed on the reverse disk (the metal plate) 28.

As described above the original disk 26 on which the metal plate 28 is laminated is taken out of the electrolyte and even when the original disk 26 is not immersed in the pure water immediately thereafter, it is similarly required that the ambient temperature (liquid temperature or air temperature) around the reverse disk 28 (also the original disk 26) and/or the temperature of the reverse disk 28 (also the original disk 26) in the step of exfoliating and/or before the step of exfoliating be controlled within±10° C. of the liquid temperature of the electrolyte.

From the above-described viewpoint, the ambient temperature around the reverse disk 28 (also the original disk 26) and/or the temperature of the reverse disk 28 (also the original disk 26) in the step of exfoliating and/or before the step of exfoliating be controlled more preferably within±5° C. of the liquid temperature of the electrolyte and most preferably within±1° C. thereof.

Incidentally, in this embodiment, pure water is used in the exfoliation bath 32. However, water is not limited to pure water and any kind of water may be used so long as it has the cleaning action. The water may contain, for example, surfactants (a nonionic surfactant, an anionic surfactant, a cationic surfactant, etc.), soaps (metallic salts of higher fatty acids), acids (hydrogen peroxide, hydrofluoric acid, etc.) and the like.

Incidentally, it is preferred that the temperature control of the original disk 26 and/or the reverse disk 28 in the step of forming the reverse disk and/or the step of exfoliating be performed within a constant-temperature device. If the temperature control of the original disk 26 and/or the reverse disk 28 in the step of forming the reverse plate and/or the step of exfoliating is performed within a constant-temperature device (for example, within a constant temperature bath or within a constant temperature oven) like this, then the temperature control is easy.

In the step of exfoliating, the reverse disk (the metal plate) 28 is exfoliated from the original disk 26 within the exfoliation bath 32. After the exfoliation of the metal plate 28 from the original disk 26, the resist layer 22 remaining on the metal plate 28 is removed and cleaned, and the metal plate 28 having reverse concavo-convex patterns as shown in FIG. 3F is obtained. And the inside diameter and outside diameter of the reverse disk 28 is punched with prescribed sizes.

Subsequently, as shown in FIG. 3G, the magnetic layer 14 is formed by sputtering etc. on the surface of the concavo-convex patterns of the master substrate 12 manufactured as described above and a protective layer is further formed as required, whereby the master disk for magnetic transfer 10 is manufactured.

Incidentally, in order to remove deformation (strains/bows) occurring during the stripping of the reverse disk 28 from the original disk 26 and during punching, the master substrate 12 manufactured as described above may be subjected to strain relieving treatment for planarization. In this treatment, for example, the master substrate 12 is placed on a face plate having a flat top surface in an electric furnace (the master substrate 12 is left on a plane surface), and subjected to heat treatment in an atmosphere at 200 to 300° C. for 30 minutes to 2 hours, for example, at 250° C. for 1 hour, whereby the deformation is corrected by relieving internal stresses.

Subsequently, the magnetic layer 14 is formed by sputtering etc. on the surface of the concavo-convex patterns of the master substrate 12 manufactured as described above and a protective layer is further formed as required, whereby the master disk for magnetic transfer 10 is manufactured.

The magnetic layer 14 is formed from a magnetic material by use of vacuum film formation processes, such as the vacuum evaporation process, the sputtering process and the ionplating process, the plating process such as the electroless plating, etc. As magnetic materials for the magnetic layer 14, it is possible to use Co, Co alloys (CoNi, CoNiZr, CoNbTaZr, etc.), Fe, Fe alloys (FeCo, FeCoNi, FeNiMo, FeAlSi, FeAl, FeTaN), Ni, and Ni alloys (NiFe). Among these, particularly, it is preferable to use FeCo and FeCoNi. The thickness m of the magnetic layer 14 is preferably in the range of 50 nm to 500 nm, and more preferably in the range of 50 nm to 300 nm.

It is preferable to provide a protective layer of diamond-like carbon (DLC), sputter carbon, etc. on the concavo-convex patterns of the magnetic layer 14, and a lubricant layer may also be provided. Also, it is more preferred that both a DCL film of 5 to 30 nm as a protective layer and a lubricant layer be present. A lubricant improves the deterioration of durability, such as the occurrence of flaws due to friction during the correction of misalignment which occurs in the process of contact with a slave disk.

An embodiment of a method of manufacturing a reverse disk related to the present invention was described above. However, the present invention is not limited to the above-described embodiment and it is possible to adopt various embodiments.

For example, in this embodiment, the reverse disk 28 is obtained by electrodepositing a metal on the original disk 26 and used as the master substrate 12. However, it is possible to adopt another manufacturing process. Concretely, it is possible to adopt a mode which involves fabricating a second original disk by electrodepositing a metal on an original disk 26, forming a magnetic layer 14 by use of this second original disk, and fabricating a metal plate (a reverse disk) having reverse concavo-convex patterns by electrodepositing a metal again by use of this second original disk, and fabricating a master substrate by punching the metal plate (the reverse plate) with a prescribed size.

Furthermore, it is also possible to adopt a mode which involves fabricating a third original disk by performing electrodeposition by use of a second original disk, fabricating a metal plate by performing electrodeposition by use of the third original disk, and exfoliating the metal plate having reverse concavo-convex patterns, whereby a master substrate is obtained.

Also, it is possible to adopt a mode which involves fabricating multiple metal plates (reverse disks) by repeatedly using the above-described second or third original disks. Incidentally, also in a case where manufacturing methods as described above are adopted, it is desirable to perform the exfoliation of the metal plate (the reverse disk) from the original disk 26 in pure water, and it is desirable that the temperature of the pure water be the same as in the above-described embodiment.

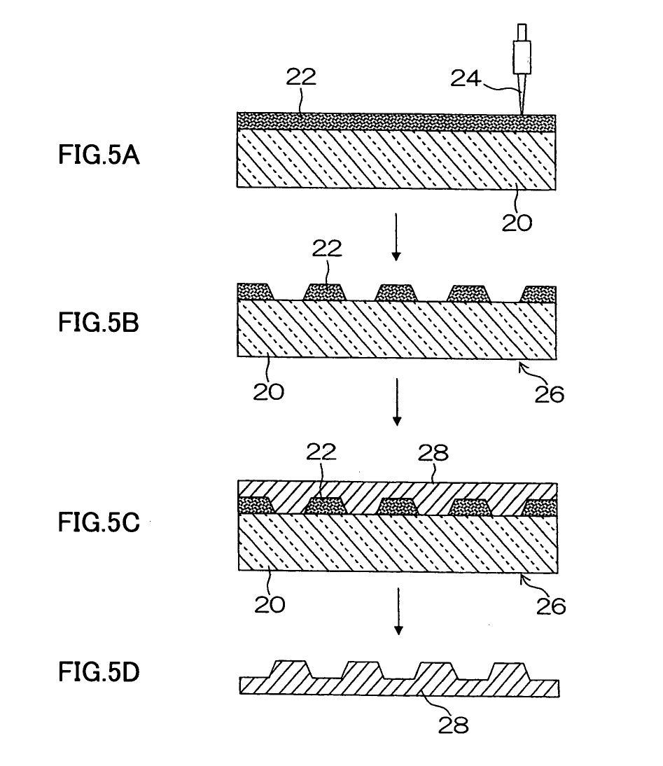

For the manufacturing process of a master disk for magnetic transfer, it is possible to adopt other modes than shown in FIGS. 3A to 3G. An example of this mode is shown in FIGS. 5A to 5D. In this example, the steps of FIGS. 5A and 5B are the same as shown in FIGS. 3A and 3B. In FIG. 5C, the metal plate 28 of a desired thickness, which is formed from a Ni metal, is laminated on the surface of the original disk 26 by performing electrodeposition (electroforming) by use of the electroforming device 30 (the step of forming the reverse plate). Subsequently, the reverse disk 28 having reverse concavo-convex patterns as shown in FIG. 5D is obtained.

Although this embodiment is applied to a method of manufacturing a master disk for magnetic transfer as described above, it can be widely applied to other fields, for example, a method of manufacturing a stamper for the manufacture of an optical disk, a manufacturing method of optical elements on which concavo-convex patterns are formed, such as an antireflection film, an antidazzling film and a diffraction grating, and also substrates and films on which concavo-convex patterns are formed and which are used in other applications.

Also, although the concavo-convex patterns of this embodiment are such that a large number of protruding patterns are arranged on a plane surface, they can also be widely applied to linear patters, for example, concentric patterns of a lenticular lens (a sheet having a semicylindrical section), a Fresnel's lens, etc.

Incidentally, when a stamper is manufactured, it is unnecessary to provide a magnetic layer as used in the above-described embodiment, and a metal plate manufactured in the same manner as in the above-described embodiment can be used just the way it is as a stamper.

In this embodiment, the step of forming the conductive layer and the step of forming the reverse disk which involves electroforming with Ni are separately provided. However, it is also possible to include the step of forming the conductive layer and the step of forming the reverse disk in one step. That is, although in the electroforming with Ni, mainly the forming of the reverse disk is performed, the forming of the conductive layer is performed at the start of the electroforming. Therefore, it can be said that one step consisting of the step of forming the conductive layer by use of Ni and the step of forming the reverse disk by use of Ni also is an equivalent scope of the technical idea of the present invention.

In an embodiment, a master disk for magnetic transfer 10 was fabricated by the above-described manufacturing method by setting the temperature t of the electrolyte of the electroforming device 30 at 55° C. and the temperature T of the pure water in the exfoliation bath 32 at 55° C. That is, the temperature t of the electrolyte and the temperature T of the pure water are identical.

In a comparative example, a master disk for magnetic transfer 10 was fabricated by the above-described manufacturing method by setting the temperature t of the electrolyte of the electroforming device 30 at 55° C. and the temperature T of the pure water in the exfoliation bath 32 at 25° C. That is, the difference between the temperature t of the electrolyte and the temperature T of the pure water is 30° C.

And master disks for magnetic transfer 10 were fabricated by exfoliating the metal plate 28 from the original disk 26 in the pure water within the exfoliation bath 32. The concavo-convex patterns on the surfaces of the master disks for magnetic transfer manufactured under the respective conditions were observed by electron micrographs and evaluated.

As a result, partially broken and lost portions in the concavo-convex patterns were not observed in the case of the embodiment. On the other hand, in the case of the comparative example, it was ascertained that partially broken and lost portion parts had occurred in the concavo-convex patterns.

What is claimed is:

1. A method of manufacturing a reverse disk, comprising the steps of:
forming a conductive layer on a surface of an original disk where concavo-convex patterns are formed;
forming a reverse disk made of a metal plate having a prescribed thickness by immersing the original disk in an electrolyte and electrodepositing a metal on a surface of the conductive layer; and
exfoliating the reverse disk from the original disk after the formation of the reverse disk,
wherein an ambient temperature around the original disk and/or a temperature of the original disk in the step of forming the conductive layer and/or before the step of forming the conductive layer are controlled within±10° C. of a liquid temperature of the electrolyte.

2. The method of manufacturing a reverse disk according to claim 1,
wherein a temperature control of the original disk in the step of forming the conductive layer is performed in a conductive layer forming device.

3. The method of manufacturing a reverse disk according to claim 1,
wherein the temperature control of the original disk and/or the reverse disk in the step of exfoliating and/or before the step of exfoliating is performed within a constant-temperature device.

4. The method of manufacturing a reverse disk according to claim 2,
wherein the temperature control of the original disk and/or the reverse disk in the step of exfoliating and/or before the step of exfoliating is performed within a constant-temperature device.

5. A method of manufacturing a reverse disk, comprising the steps of:
forming a conductive layer on a surface of an original disk where concavo-convex patterns are formed;
forming a reverse disk made of a metal plate having a prescribed thickness by immersing the original disk in an electrolyte and electrodepositing a metal on the surface of the conductive layer; and
exfoliating the reverse disk from the original disk after the formation of the reverse disk,
wherein the ambient temperature around the reverse disk and/or the temperature of the reverse disk in the step of exfoliating and/or before the step of exfoliating are controlled within±10° C. of the liquid temperature of the electrolyte.

6. The method of manufacturing a reverse disk according to claim 5,
wherein the temperature control of the original disk in the step of forming the conductive layer is performed within a conductive layer forming device.

7. The method of manufacturing a reverse disk according to claim 5,
wherein the temperature control of the original disk and/or the reverse disk in the step of exfoliating and/or before the step of exfoliating is performed within a constant-temperature device.

8. The method of manufacturing a reverse disk according to claim 6, wherein the temperature control of the original disk and/or the reverse disk in the step of exfoliating and/or before the step of exfoliating is performed within a constant-temperature device.

9. A method of manufacturing a reverse disk, comprising the steps of:
forming a conductive layer on a surface of an original disk where concavo-convex patterns are formed;
forming a reverse disk made of a metal plate having a prescribed thickness by immersing the original disk in an electrolyte and electrodepositing a metal on the surface of the conductive layer; and
exfoliating the reverse disk from the original disk after the formation of the reverse disk,
wherein the ambient temperature around the original disk and/or the temperature of the original disk in the step of forming the conductive layer and/or before the step of forming the conductive layer are controlled within±5° C. of the liquid temperature of the electrolyte.

10. The method of manufacturing a reverse disk according to claim 9,
wherein the temperature control of the original disk in the step of forming the conductive layer is performed within a conductive layer forming device.

11. The method of manufacturing a reverse disk according to claim 9,
wherein the temperature control of the original disk and/or the reverse disk in the step of exfoliating and/or before the step of exfoliating is performed within a constant-temperature device.

12. A method of manufacturing a reverse disk, comprising the steps of:
forming a conductive layer on a surface of an original disk where concavo-convex patterns are formed;
forming a reverse disk made of a metal plate having a prescribed thickness by immersing the original disk in an electrolyte and electrodepositing a metal on the surface of the conductive layer; and
exfoliating the reverse disk from the original disk after the formation of the reverse disk,
wherein the ambient temperature around the reverse disk and/or the temperature of the reverse disk in the steps of exfoliating and/or before the steps of exfoliating are controlled within±5° C. of the liquid temperature of the electrolyte.

13. The method of manufacturing a reverse disk according to claim 12,
wherein the temperature control of the original disk in the step of forming the conductive layer is performed within a conductive layer forming device.

14. The method of manufacturing a reverse disk according to claim 12,
wherein the temperature control of the original disk and/or the reverse disk in the step of exfoliating and/or before the step of exfoliating is performed within a constant-temperature device.

15. A method of manufacturing a reverse disk, comprising the steps of:
forming a conductive layer on a surface of an original disk where concavo-convex patterns are formed;
forming a reverse disk made of a metal plate having a prescribed thickness by immersing the original disk in an electrolyte and electrodepositing a metal on the surface of the conductive layer; and
exfoliating the reverse disk from the original disk after the formation of the reverse disk,
wherein the ambient temperature around the original disk and/or the temperature of the original disk in the step of forming the conductive layer and/or before the step of forming the conductive layer and the ambient temperature around the reverse disk and/or the temperature of the reverse disk in the step of exfoliating and/or before the step of exfoliating are controlled within±10° C. of the liquid temperature of the electrolyte.

16. The method of manufacturing a reverse disk according to claim 15,
wherein the temperature control of the original disk in the step of forming the conductive layer is performed within a conductive layer forming device.

17. The method of manufacturing a reverse disk according to claim 15,
wherein the temperature control of the original disk and/or the reverse disk in the step of exfoliating and/or before the step of exfoliating is performed within a constant-temperature device.

18. A method of manufacturing a reverse disk, comprising the steps of:
forming a conductive layer on a surface of an original disk where concavo-convex patterns are formed;
forming a reverse disk made of a metal plate having a prescribed thickness by immersing the original disk in an electrolyte and electrodepositing a metal on the surface of the conductive layer; and
exfoliating the reverse disk from the original disk after the formation of the reverse disk,
wherein the ambient temperature around the original disk and/or the temperature of the original disk in the step of forming the conductive layer and/or before the step of forming the conductive layer and the ambient temperature around the reverse disk and/or the temperature of the reverse disk in the step of exfoliating and/or before the step of exfoliating are controlled within±5° C. of the liquid temperature of the electrolyte.

19. The method of manufacturing a reverse disk according to claim 18,
wherein the temperature control of the original disk in the step of forming the conductive layer is performed within a conductive layer forming device.

20. The method of manufacturing a reverse disk according to claim 18,
wherein the temperature control of the original disk and/or the reverse disk in the step of exfoliating and/or before the step of exfoliating is performed within a constant-temperature device.
